(19) United States
(12) Patent Application Publication
(10) Pub. No.: US 2026/0224954 A1
(43) Pub. Date: Aug. 6, 2026

(54) CORE STRUNG SPORTS PADDLE

(71) Applicant: Mitch Junkins, Newport Beach, CA (US)

(72) Inventor: Mitch Junkins, Newport Beach, CA (US)

(21) Appl. No.: 19/530,861

(22) Filed: Feb. 5, 2026

Related U.S. Application Data
(60) Provisional application No. 63/754,416, filed on Feb. 5, 2025.

(51) Int. Cl. A63B 59/42; A63B 60/14; A63B 60/16; A63B 102/08; B32B 5/02; B32B 5/18; B32B 5/24

(52) U.S. Cl. CPC A63B 59/42; A63B 60/14; A63B 60/16; B32B 5/028; B32B 5/18; B32B 5/245; A63B 2102/08; A63B 2209/02; B32B 2266/0214

(57) ABSTRACT

An apparatus and methods are provided for a sports paddle for pickleball, tennis, smashball, ping pong, or racquetball. The sports paddle comprises a planar portion defining opposing flat surfaces for striking a ball and a handle portion for grasping in a hand. A skin layer encloses the planar portion and the handle portion. Rounded edges are disposed around the planar portion and the handle portion. The planar portion comprises an internal string core coupled with structured foam layers and surrounded by carbon fiber layers. A synthetic or polymeric grip is wrapped around the handle portion to provide stability and firmness for a player. A binding secures the grip to a neck of the planar portion. An end cap placed at an end of the handle provides support and protection of the paddle.

### PRIORITY

This application claims the benefit of and priority to U.S. Provisional Application, entitled “Core Strung Sports Paddle,” filed on Feb. 5, 2025, and having application Ser. No. 63/754,416, the entirety of said application being incorporated herein by reference.

### FIELD

Embodiments of the present disclosure generally relate to paddles for sports. More specifically, embodiments of the disclosure relate to an apparatus and methods for a sports paddle for pickleball, tennis, smashball, paddle tennis, ping pong, or racquetball.

### BACKGROUND

Pickleball typically is played on a badminton-sized court with a tennis-like net, using a perforated plastic hollow ball. The ball is struck by players using pickleball paddles that resemble large table tennis paddles. Pickleball paddles generally are be made from wood, graphite, aluminum, carbon fiber, fiberglass, composite materials, and other suitable materials. They often have a polypropylene or foam core.

Pickleball paddles may be constructed by cutting or machining a large sheet of material into the shape of a paddle or by surrounding the core in a composite material and allowing it to cure in a fixed tool. As shown in FIG. 1, a conventional paddle 100 generally includes a ball striking, planar portion 104 and a handle portion 108. The planar portion 104 defines opposing flat surfaces. An outer edge guard 112 generally is provided around the planar portion 104 to protect core material comprising the planar portion 104. The planar portion 104 extends downward into the handle portion 108. A synthetic or polymeric grip 116 is wrapped around the handle portion 108 to provide stability and firmness for the player. A binding 120 secures the grip 116 to a neck 124 of the paddle 100. An end cap 128 placed at an end of the handle 108 provides support and protection of the paddle 100.

The opposing flat surfaces of the paddle 100 may be covered by a skin or protective layers. The skin is sometimes called a “laminate” or “face sheet.” In embodiments where a core material is bonded to a skin material, the paddle 100 is referred to as a “composite panel” or “sandwich panel.” The skin material may comprise thin, but stiff, skins while the core material may comprise a lightweight, but thick, core. The core material generally is low strength material, but its greater thickness provides the sandwich panel with high bending stiffness and low overall density.

The core material may comprise open-cell-structures and closed-cell-structured foams such as polyvinylchloride, polyurethane, polyethylene or polystyrene foams, balsa wood, syntactic foams, honeycombs, and the like. Open-cell and closed-cell metal foam can also be used as core materials.

Laminates comprising glass or carbon fiber-reinforced thermoplastics or thermoset polymers, such as unsaturated polyesters, epoxies, and the like, may be used as skin materials. Sheet metal may also be used as skin material.

A drawback to conventional paddles is that they tend to develop weak spots or soft spots, known as “dead spots.” Dead spots typically form at locations where wear damage occurs, or where the adhesive fails, resulting in delamination of the skin material from the core material. Dead spots can also occur because edges of conventional paddles are held together only by a flexible rail guard that allows the paddle edges to flex during ball impacts.

Another drawback to conventional paddles comprising sandwich panels, such as the paddle 100, arises due to edge treatments. Some manufacturers apply a U-channel or other type of molding, such as the edge guard 112, to protect the edge of the planar portion 104 and enclose the periphery of the core material disposed between the skin materials. The edge guard 112 forms a lip 132 around the planar portion 104 that creates interference when striking the ball in this area of the paddle 100. Further, some manufacturers finish the edge with a composite material. Unfortunately, the composite material renders the edge of the paddle 100 overly fragile, resulting in damage if the ground or a hard object is struck during play. Moreover, many methods of finishing the edge of the paddle 100 cause reliability issues, such as the edge treatment tending loosen and separate or fall off with age or stress. Additionally, in some instances a flexible rail guard may be used, but such rail guards often cause undesirable ball trajectories when struck by the ball during play.

There is a need, therefore, for a paddle that does not require an edge treatment, such as the edge guard 112 shown in FIG. 1.

### SUMMARY

An apparatus and methods are provided for a sports paddle for pickleball, tennis, smashball, ping pong, or racquetball. The sports paddle comprises a planar portion defining opposing flat surfaces for striking a ball and a handle portion for grasping in a hand. A skin layer encloses the planar portion and the handle portion. Rounded edges are disposed around the planar portion and the handle portion. The planar portion comprises an internal string core coupled with structured foam layers and surrounded by carbon fiber layers. A synthetic or polymeric grip is wrapped around the handle portion to provide stability and firmness for a player. A binding secures the grip to a neck of the planar portion. An end cap placed at an end of the handle provides support and protection of the paddle.

In an exemplary embodiment, a sports paddle comprises: a planar portion defining opposing flat surfaces for striking a ball; a handle portion for grasping in a hand; and a grip wrapped around the handle portion to provide stability and firmness for a player.

In another exemplary embodiment, the grip is wrapped around EVA foam portions that are coupled with the handle portion. In another exemplary embodiment, a binding secures the grip to a neck of the planar portion. In another exemplary embodiment, an end cap placed at an end of the handle provides support and protection of the paddle.

In another exemplary embodiment, the planar portion includes an internal string core surrounded by structured foam layers. In another exemplary embodiment, the internal string core is strung and dynamically tensioned on a rigid portion. In another exemplary embodiment, the rigid portion comprises carbon fiber or another similar material capable of supporting the internal string core. In another exemplary embodiment, the structured foam layers comprise a first structured foam layer positioned above the internal string core and a second structured foam layer disposed below the internal string core. In another exemplary embodiment, the first and second structured foam layers comprise any of polyvinylchloride, polyurethane, polyethylene or polystyrene foams, balsa wood, syntactic foams, honeycombs, and any combination thereof.

In another exemplary embodiment, a first rigid layer is disposed outside the first structured foam layer and a second rigid layer is disposed outside the second structured foam layer. In another exemplary embodiment, the first and second rigid layers comprise any of multilayer carbon fiber, fiberglass, or another similar material. In another exemplary embodiment, a skin layer is wrapped around the first and second rigid layers.

In another exemplary embodiment, the planar portion includes a core material surrounded by an external string core. In another exemplary embodiment, the external string core is strung around the exterior of a rigid portion. In another exemplary embodiment, the external string core and the rigid portion define an interior volume that houses the core material. In another exemplary embodiment, the rigid portion comprises carbon fiber or another similar material capable of supporting the external string core. In another exemplary embodiment, the external string core can be strung on either one or both sides of the rigid portion.

In another exemplary embodiment, a first rigid layer and a second rigid layer are disposed outside the external string core. In another exemplary embodiment, the first and second rigid layers comprise any of multilayer carbon fiber, fiberglass, or another similar material. In another exemplary embodiment, a skin layer is wrapped around the first and second rigid layers.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a perspective view of an exemplary embodiment of a conventional paddle that includes an edge guard;

FIG. 2 illustrates a side view of an exemplary embodiment of a sports paddle, in accordance with the present disclosure;

FIG. 3 illustrates an edge view of an exemplary embodiment of a sports paddle that includes rounded edges, according to the present disclosure;

FIG. 4 illustrates a side view of an exemplary embodiment of a sports paddle that includes a core material in accordance with the present disclosure;

FIG. 5 illustrates an exploded side view of an exemplary embodiment of a sports paddle that includes an internal string core surrounded by structured foam layers in accordance with the present disclosure;

FIG. 6 illustrates a close-up view of an exemplary embodiment of a sports paddle that includes a core material surrounded by an external string core in accordance with the present disclosure; and

FIG. 7 illustrates an exploded side view of an exemplary embodiment of a sports paddle that includes a core material surrounded by an external string core according to the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the paddle and methods disclosed herein may be practiced without these specific details. In other instances, specific numeric references such as “first core material,” may be made. However, the specific numeric reference should not be interpreted as a literal sequential order but rather interpreted that the “first core material” is different than a “second core material.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Pickleball paddles generally are be made from wood, graphite, aluminum, fiberglass, carbon fiber, composite materials, and other suitable materials. In many embodiments, a core material is bonded between sheets of a skin material. A drawback to conventional paddles is that they tend to develop dead spots at locations where wear damage occurs, or where the adhesive fails, resulting in delamination of the skin material from the core material. Another drawback arises due to edge treatments, such as an edge guard used to protect the edge of the planar portion and enclose the periphery of the core material disposed between the skin materials. The edge guard forms a lip around the planar portion that creates interference when striking the ball in this area of the paddle. Embodiments presented herein provide a paddle that does not require an edge guard, allowing the paddle to be made out of a continuous material that encloses the core material as well as any structures incorporated into the core.

FIG. 2 illustrates an exemplary embodiment of a paddle 140 that obviates any need for an edge treatment, such as the edge guard 112, in accordance with the present disclosure. The paddle 140 includes a planar portion 144 and a handle portion 148. The planar portion 144 defines opposing flat surfaces for striking a pickleball. The planar portion 144 comprises a core material, as described herein. The planar portion 144 extends into the handle portion 148. A synthetic or polymeric grip 152 is wrapped around the handle portion 148 to provide stability and firmness for the player. In some embodiments, the grip 152 may be wrapped around hardwood portions (not shown) that may be coupled with the handle portion 148. In some embodiments, the grip 152 may be wrapped around portions comprising EVA foam (not shown), or another suitable material, that may be coupled with the handle portion 148. It is contemplated that a wide variety of materials may comprise the portions coupled with the handle portion 148, without limitation. A binding 156 secures the grip 152 to a neck 160 of the paddle 140. An end cap 164 placed at an end of the handle 148 provides support and protection of the paddle 140.

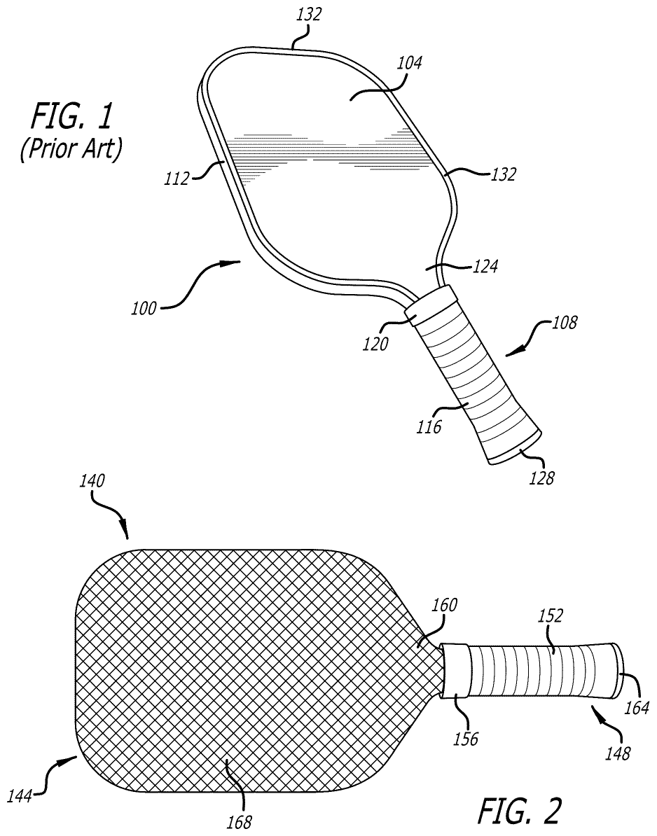

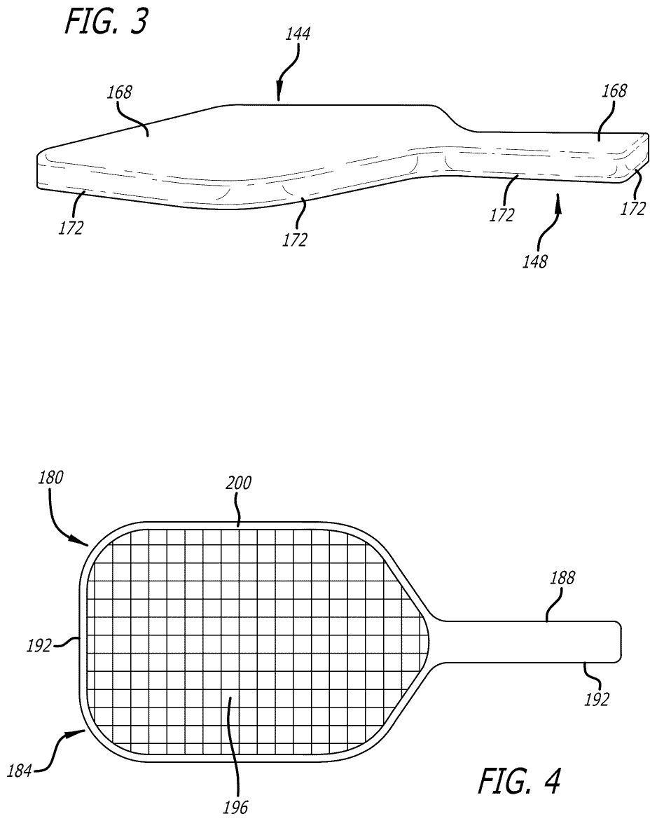

As shown in FIG. 2, the core material comprising paddle 140 is wrapped within a skin layer 168. Unlike conventional paddles that comprise a sandwich panel structure, the skin layer 168 may surround an entirety of the core material. As shown in FIG. 3, enclosing the core material within the skin layer 168 enables incorporating rounded edges 172 into the planar portion 144 and the handle portion 148 without requiring an edge treatment, such as the edge guard 112 shown in FIG. 1. Once the skin layer 168 is applied to the planar portion 144 and the handle portion 148, the grip 152, the binding 156, and the end cap 164 may be installed onto the paddle 140 as shown in FIG. 2.

The skin layer 168 may comprise fiberglass, graphite, carbon fiber, or other suitable material that offers a practitioner a sense of control, feel, or power during play. In some embodiments, the opposing sides of the planar portion 144 may be covered by skin layers 168 comprising different materials, thereby forming a “hybrid” paddle that offers differing performance on the opposing sides. For example, one side may offer greater power while the other side offers greater precision. Further, in some embodiments, the skin layers 168 may be laminates comprising glass or carbon fiber-reinforced thermoplastics or thermoset polymers, such as unsaturated polyesters, epoxies, and the like, as well as sheet metal, without limitation. Further, in some embodiments, the skin layers 168 may be configured to provide specific performance properties, such as, for example, a consistent traction. In some embodiments, the skin layers 168 may include permanent or removeable film portions that are configured to provide desired performance properties, such as a consistent traction, without limitation.

The core material may comprise open-cell-structures and closed-cell-structured foams such as polyvinylchloride, polyurethane, polyethylene or polystyrene foams, balsa wood, syntactic foams, honeycombs, and the like. Open-cell and closed-cell metal foam can also be used as core materials. In one embodiment, the core material comprises a complete polypropylene honeycomb core that is wrapped in 4 layers of pre-preg carbon fiber. The carbon fiber is adhered to the honeycomb and baked under compression to form a “boned surface.” In one embodiment, the core material comprises between 20-lb. and 24-lb. foam. Other suitable materials will be apparent to those skilled in the art.

It is contemplated that any of various structures may be incorporated into the planar portion before being wrapped in the skin layers 168, as described herein. For example, FIG. 4 illustrates an exemplary embodiment of a paddle 180 that includes a structured planar portion 184 and a handle portion 188 in accordance with the present disclosure. The planar portion 184 and the handle portion 188 have rounded edges 192, as described herein. The planar portion 184 comprises a core 196 surrounded by a rigid portion 200. The core 196 and the rigid portion 200 may comprise any of various materials that are found to provide a product that can be more efficiently produced, that is more aesthetically pleasing, that provides greater consistency of function, and is more reliable than products produced using other technologies. In one exemplary embodiment, the rigid portion 200 comprises a carbon fiber frame while the core 196 comprises an internal string core that is sandwiched between polypropylene or foam layers.

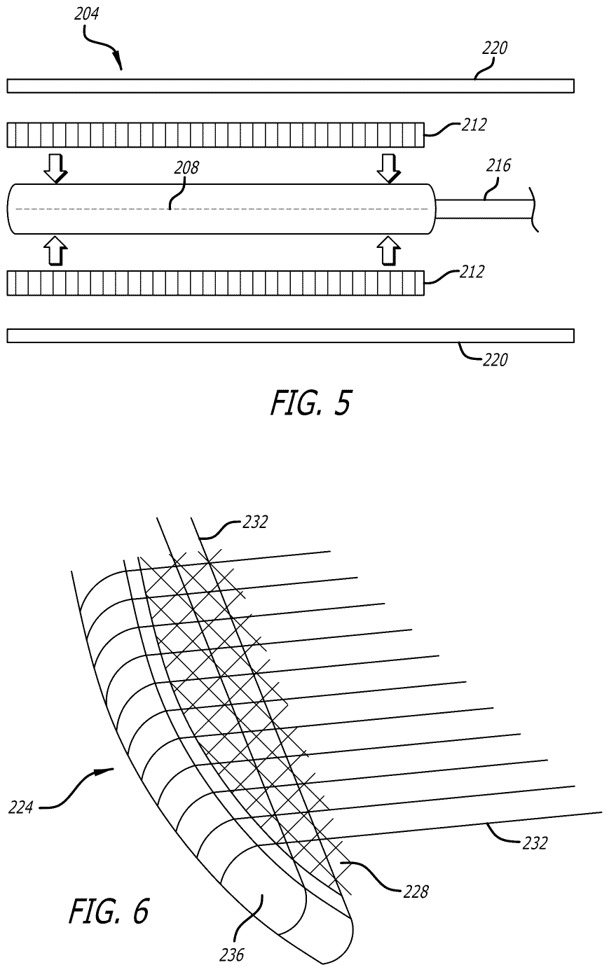

FIG. 5 illustrates an exploded side view of an exemplary embodiment of a sports paddle 204 that includes an internal string core 208 surrounded by structured foam layers 212 in accordance with the present disclosure. The string core 208 is strung, and dynamically tensioned, on a rigid portion 216. Like the rigid portion 200 mentioned above, the rigid portion 216 comprises carbon fiber or another similar material capable of supporting the string core 208. A structured foam layer 212 is positioned above and below the string core 208. The structured foam layers 212 can comprise any of polyvinylchloride, polyurethane, polyethylene or polystyrene foams, balsa wood, syntactic foams, honeycombs, and the like, without limitation. As shown in FIG. 5, a rigid layer 220 is disposed outside each structured foam layer 212. The rigid layers 220 can comprise multilayer carbon fiber, fiberglass, or another similar material, without limitation. It is contemplated that, in some embodiments, the paddle 204 can be wrapped within a skin layer 168, as described herein.

FIG. 6 illustrates a close-up view of an exemplary embodiment of a sports paddle 224 that includes a core material 228 surrounded by an external string core 232 in accordance with the present disclosure. As shown in FIG. 6, the string core 232 is strung around the exterior of a rigid portion 236. The rigid portion 236 can comprise carbon fiber or another similar material. It is contemplated that the string core 232 can be strung on either one or both sides of the rigid portion 236. In embodiments wherein the string core 232 is strung on both sides of the rigid portion 236, the string core 232 and the rigid portion 236 surround an interior volume that can house the core material 228.

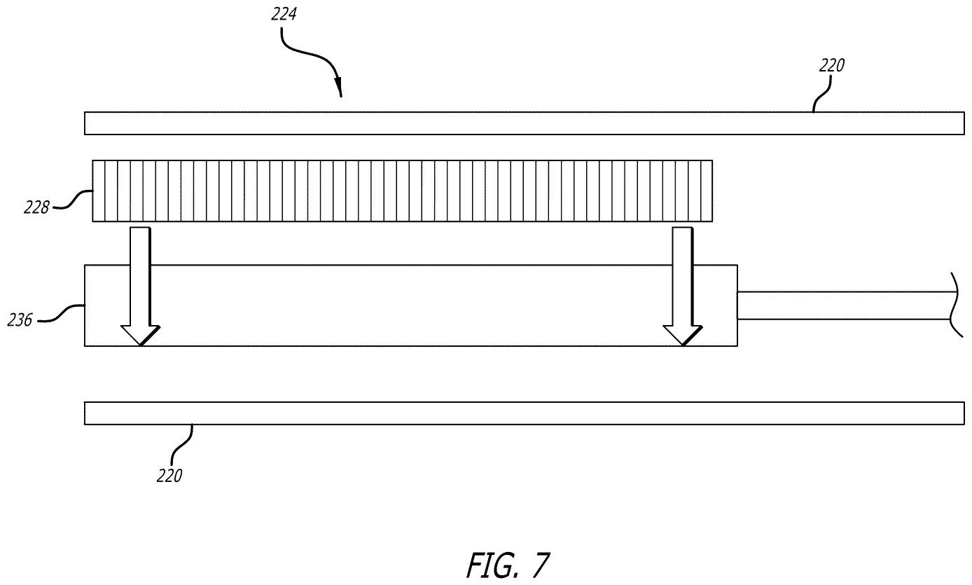

FIG. 7 illustrates an exploded side view of an exemplary embodiment of a sports paddle 224 that includes a core material 228 surrounded by an external string core 232 that is strung on a rigid portion 236 according to the present disclosure. The string core 232 can be strung on one or both sides of the rigid portion 236. As shown in FIG. 7, the core material 228 is disposed within the rigid portion 236. In embodiments wherein the string core 232 is strung on both sides of the rigid portion 236, the string core 232 and the rigid portion 236 surround an interior volume that houses the core material 228. The core material 228 can comprise any of polyvinylchloride, polyurethane, polyethylene or polystyrene foams, balsa wood, syntactic foams, honeycombs, and the like, without limitation. As further shown in FIG. 7, a rigid layer 220 is disposed outside the core material 228 and the string core 232. The rigid layers 220 can comprise multilayer carbon fiber, fiberglass, or another similar material, without limitation. It is contemplated that, in some embodiments, the paddle 224 can be wrapped within a skin layer 168, as described herein.

While the paddle and methods have been described in terms of particular variations and illustrative figures, those of ordinary skill in the art will recognize that the paddle is not limited to the variations or figures described. In addition, where methods and steps described above indicate certain events occurring in certain order, those of ordinary skill in the art will recognize that the ordering of certain steps may be modified and that such modifications are in accordance with the variations of the paddle. Additionally, certain of the steps may be performed concurrently in a parallel process when possible, as well as performed sequentially as described above. To the extent there are variations of the paddle, which are within the spirit of the disclosure or equivalent to the paddle found in the claims, it is the intent that this patent will cover those variations as well. Therefore, the present disclosure is to be understood as not limited by the specific embodiments described herein, but only by scope of the appended claims.

What is claimed is:

1. A sports paddle, comprising:
a planar portion defining opposing flat surfaces for striking a ball;
a handle portion for grasping in a hand; and
a grip wrapped around the handle portion to provide stability and firmness for a player.

2. The sports paddle of claim 1, wherein the grip is wrapped around EVA foam portions that are coupled with the handle portion.

3. The sports paddle of claim 1, wherein a binding secures the grip to a neck of the planar portion.

4. The sports paddle of claim 1, wherein an end cap placed at an end of the handle provides support and protection of the paddle.

5. The sports paddle of claim 1, wherein the planar portion includes an internal string core surrounded by structured foam layers.

6. The sports paddle of claim 5, wherein the internal string core is strung and dynamically tensioned on a rigid portion.

7. The sports paddle of claim 6, wherein the rigid portion comprises carbon fiber or another similar material capable of supporting the internal string core.

8. The sports paddle of claim 7, wherein the structured foam layers comprise a first structured foam layer positioned above the internal string core and a second structured foam layer disposed below the internal string core.

9. The sports paddle of claim 8, wherein the first and second structured foam layers comprise any of polyvinylchloride, polyurethane, polyethylene or polystyrene foams, balsa wood, syntactic foams, honeycombs, and any combination thereof.

10. The sports paddle of claim 9, wherein a first rigid layer is disposed outside the first structured foam layer and a second rigid layer is disposed outside the second structured foam layer.

11. The sports paddle of claim 10, wherein the first and second rigid layers comprise any of multilayer carbon fiber, fiberglass, or another similar material.

12. The sports paddle of claim 11, wherein a skin layer is wrapped around the first and second rigid layers.

13. The sports paddle of claim 1, wherein the planar portion includes a core material surrounded by an external string core.

14. The sports paddle of claim 13, wherein the external string core is strung around the exterior of a rigid portion.

15. The sports paddle of claim 14, wherein the external string core and the rigid portion define an interior volume that houses the core material.

16. The sports paddle of claim 15, wherein the rigid portion comprises carbon fiber or another similar material capable of supporting the external string core.

17. The sports paddle of claim 16, wherein the external string core can be strung on either one or both sides of the rigid portion.

18. The sports paddle of claim 17, wherein a first rigid layer and a second rigid layer are disposed outside the external string core.

19. The sports paddle of claim 18, wherein the first and second rigid layers comprise any of multilayer carbon fiber, fiberglass, or another similar material.

20. The sports paddle of claim 19, wherein a skin layer is wrapped around the first and second rigid layers.
